(19) United States
(12) Patent Application Publication
(10) Pub. No.: US 2020/0034397 A1
(43) Pub. Date: Jan. 30, 2020

(54) APPLICATION EXTENSION FOR PROVIDING RELEVANT CONTENT ITEMS

(71) Applicant: Coursera, Inc., Mountain View, CA (US)

(72) Inventors: Roshan Sumbaly, Sunnyvale, CA (US); Raghav Pasari, Mountain View, CA (US); Yun Hao, Mountain View, CA (US); Yuan Liu, Milpitas, CA (US)

(21) Appl. No.: 16/523,841

(22) Filed: Jul. 26, 2019

Related U.S. Application Data
(60) Provisional application No. 62/711,191, filed on Jul. 27, 2018.

(51) Int. Cl. G06F 16/957; G06F 16/958; G06F 16/955; G06F 16/74; G09B 5/12

(52) U.S. Cl. CPC G06F 16/957; G06F 16/972; G09B 5/12; G06F 16/748; G06F 16/955

(57) ABSTRACT

A supplemental content provider provides extensions to client devices. The extension receives information on third-party content displayed to a user of a client device, and retrieves a list of supplemental items relevant to the third-party content. The extension displays the list of supplemental items such that users can retain view of the third-party content while browsing the list of relevant items. The extension allows users to view relevant items without submitting search queries or disengaging from the third-party content. The supplemental items may be videos of an online education system. The extension may also allow users to gain access to the supplemental items without opening a new page of the application.

### CROSS-REFERENCE TO RELATED APPLICATIONS

This application claims the benefit of U.S. Provisional Patent Application No. 62/711,191, filed Jul. 27, 2018, which is hereby incorporated by reference in its entirety.

### BACKGROUND

This invention relates generally to providing content items, and particularly to providing relevant content items using a browser extension.

Users of client devices browse pages containing content provided by a third-party system using applications on the client devices. For example, the third-party system may be a news provider that provides viewable content in the form of news articles or videos that can be viewed through a browser application on the client device. Often times, it is advantageous to serve users with supplemental content items (“supplemental items”) managed by entities other than the third-party system that are usually accessible on pages different from those that display the third-party content. For example, a lecture video on a video-sharing website containing information on how solar cells work may be useful to a user viewing a news article on solar cells on an online news website.

One way to retrieve supplemental information is for the user to subjectively identify one or more keywords related to the third-party content, and submit a search query based on the keywords to retrieve relevant items. For example, the user viewing the news article may submit a search query “how do solar cells work” to the video-sharing website to retrieve relevant lecture videos that discuss the technical aspects of solar cells. However, users often have to disengage from the page of the third-party content to browse or access the results of the search query because they are displayed on new pages or windows that obscure the third-party content.

Moreover, user-identified keywords may not be the most optimal for retrieving relevant supplemental content items, because they are subjectively determined by users who sometimes do not have in-depth knowledge of the third-party content. For example, compared to the user-submitted search query “how do solar cells work,” a search query that additionally includes technical terms disclosed in the news article (e.g., “p-n junctions,” “photovoltaic effect”) may retrieve videos that contain more information on the technical aspects of solar cells compared to those retrieved by the user-submitted query.

### SUMMARY

A supplemental content provider provides extensions to client devices. The extension receives information on third-party content displayed to a user of a client device, and retrieves a list of supplemental items relevant to the third-party content. The extension displays the list of supplemental items such that users can retain view of the third-party content while browsing the list of relevant items. The extension allows users to view relevant items without submitting search queries or disengaging from the third-party content. In one embodiment, the supplemental items are videos of an online education system. In one embodiment, the extension also allows users to gain access to the supplemental items without opening a new page of the application.

Specifically, the supplemental content provider system provides an extension that can be installed on an application of a client device. The application can be used to browse content generated by a third-party system. Responsive to a trigger, the extension provides the supplemental content provider with information on the page of the third-party content displayed to the user of the client device 116. The supplemental content provider receives the page information, and identifies a set of keywords that characterize the third-party content. For example, a set of keywords identified from a news article on solar cells may include “solar cell,” “photovoltaics,” “Germany,” “p-n junctions,” and “semiconductors.” The supplemental content provider selects one or more supplemental items that are relevant to the identified keywords.

The supplemental content provider provides the list of relevant supplemental items to the application extension. The extension displays the list of supplemental items on the client device such that users can retain view of the third-party content, and continue to engage with the third-party content if needed. For example, when the application is a browser application, the extension may display the relevant items in a user interface (UI) overlaid on a side of the third-party content page. In one embodiment, the extension allows users to access the supplemental items without opening a new page of the application. For example, responsive to a video selection by the user, the extension may generate a UI (e.g., modal window) overlaid on the page of the third-party content for playing the selected video.

### BRIEF DESCRIPTION OF DRAWINGS

FIG. 1 is a system environment for displaying supplemental items relevant to third-party content according to one embodiment.

FIG. 2A illustrates an example third-party content page according to one embodiment.

FIG. 2B illustrates the example third-party content page overlaid with a UI for displaying relevant items according to one embodiment. FIG. 2C illustrates the example third-party content page overlaid with a UI for accessing a selected item according to one embodiment.

FIG. 3A illustrates an example of a page including third-party content and a list of relevant supplemental items, according to one embodiment. FIG. 3B illustrates accessing a selected supplemental item within the example page of FIG. 3A, according to one embodiment.

FIG. 4 is a block diagram illustrating components of the supplemental content provider 110, according to one embodiment.

FIG. 5 is an example flowchart for displaying supplemental items relevant to third-party content on a client device, according to one embodiment.

FIG. 6 is an example flowchart for providing supplemental items related to third-party content on a client device, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

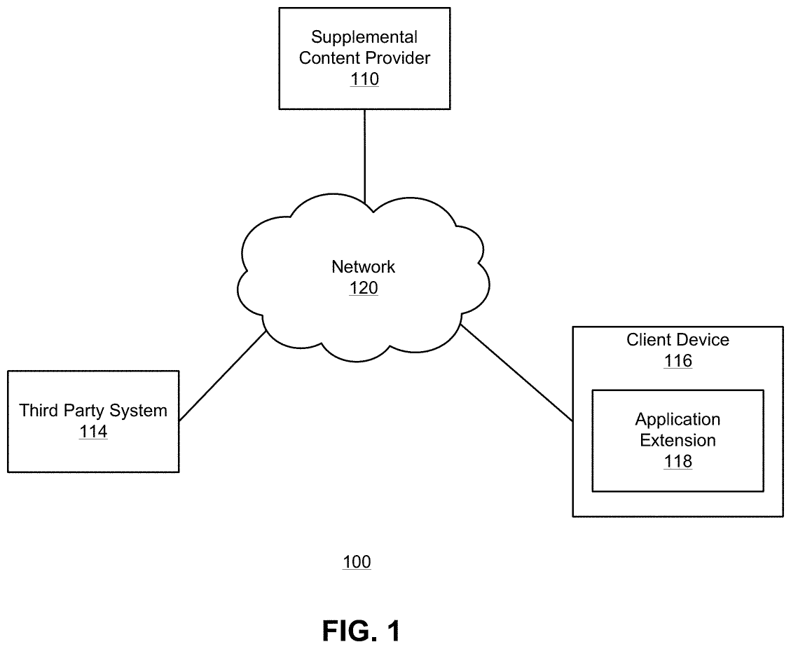

FIG. 1 is a system environment 100 for displaying supplemental items relevant to third-party content according to one embodiment. The system environment 100 shown in FIG. 1 comprises one or more client devices 116, a network 120, a supplemental content provider 110, and a third-party system 114. In alternative configurations, different and/or additional components may be included in the system environment 100.

The third-party system 114 provides various types of content to users of client devices 116. For example, the third-party system 114 may be an online news provider that provides content in the form of news articles and news videos. As another example, the third-party system 114 may be an e-commerce website that provides content in the form of product listings, in which each listing includes a photograph, the sale value, and customer reviews of a corresponding product. As yet another example, the third-party system 114 may be an e-mail provider that provides content in the form of e-mails received and sent by a user of the client device 116.

The third-party system 114 may organize content across one or more pages of a website or web application. For example, a main page of an online news provider may show a collection of news article headlines as hypertexts, in which each hypertext is linked to a page containing the corresponding news article. Responsive to a request to display a page, the third-party system 114 provides rendering information to the client device 116 that can be processed to display the page on the client device 116. Along with the third-party content, the rendering information may include information on other components, such as advertisement slots and links to other related articles that will be displayed on the page. In addition, the rendering information may also include presentation information specifying how the different elements are arranged (e.g., layout, color) on the page.

The client device 116 is a computing device capable of receiving user input as well as communicating via the network 120. While a single client device 116 is illustrated in FIG. 1, in practice many client devices 116 may communicate with the systems in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120.

The client device 116 includes an application to interact with the third-party system 114 and the supplemental content provider 110. In one embodiment, the application is a browser application used to view content displayed on a website or web application of the third-party system 114. In another embodiment, the application is a native application (e.g., mobile application) of the third-party system running on the client device 116 itself. Responsive to a request to access a page managed by the third-party system 114, the application receives rendering information that can be processed to “render” or display the page containing the third-party content, along with other components, on the client device 116.

In one embodiment, the application includes an extension 118 that provides information on the third-party content to the supplemental content provider 110, and receives a list of supplemental items relevant to the third-party content. The extension 118 displays the list of relevant items on the client device 116 through, for example, a user interface (UI) such that the user retains view of the third-party content. The supplemental items are content items managed by the supplemental content provider 110 that are typically not available on the page displaying the third-party content. The supplemental items can be videos, wikis, and/or webpages. For example, the extension 118 may display a list of lecture videos related to solar cells that are managed by an online education system when the application displays a news article on solar cells managed by an online news provider. In one embodiment, the user of a client device 116 may install the extension 118 by downloading and installing a corresponding extension package through the application.

Although relevant supplemental information can be identified by the user by submitting a search query to, for example, a website of the supplemental content provider 110, this often requires users to disengage from the page of the third-party content. This is because submitting the search query and displaying the results of the search query usually occur on new pages of the application that obscure the third-party content. In contrast, the extension 118 allows relevant items to be displayed to the user while the user maintains view of the content. Thus, the user of the client device 116 can continue to engage with the third-party content as relevant items are being identified and displayed to the user.

Moreover, user-identified keywords in the search query may not be the most optimal for retrieving relevant supplemental items because keywords for search queries are, for example, often subjectively determined by users who do not have in-depth knowledge of the third-party content. For example, a basic user-submitted query “how do solar cells work?” submitted to a video-sharing website does not take into account technical terms such as “p-n junction” and “photovoltaic effect” contained in the article that may help identify videos more useful to the user compared to those retrieved based on the user-submitted query. In contrast, the extension 118 provides the supplemental content provider 110 with information on the third-party content, and receives a list of supplemental items that are determined to be relevant based on the third-party content itself. This allows the extension 118 to receive supplemental items that may be more relevant and useful to the user of the client device 116 than those retrieved from subjective user-submitted queries.

Specifically, the extension 118 provides the supplemental content provider 110 with information on the third-party content, and receives the list of supplemental items relevant to the third-party content. In one embodiment, the extension 118 may provide the supplemental content provider 110 with information on the page displaying the third-party content. For example, the extension 118 may provide the supplemental content provider 110 with the URL address for the page that is being browsed by the client device 116. As another example, the extension 118 may provide the supplemental content provider 110 with the code of the page in standard markup language. In another embodiment, the extension 118 may filter out components (e.g., links to other articles, advertisements) that are not directly related to the third-party content, and provide the supplemental content provider 110 with the third-party content itself. For example, the extension 118 may extract the text of a news article, and provide the supplemental content provider 110 with only the text.

In one embodiment, the extension 118 may also provide the supplemental content provider 110 with authentication information of the user of the client device 116 that the supplemental content provider 110 can use to verify whether the user is allowed to access the supplemental items. For example, the authentication information may be an authentication cookie that was stored by the application of the client device 116 responsive to a request by the supplemental content provider 110.

Responsive to providing information on the third-party content, the extension 118 receives a list of supplemental items that are relevant to the third-party content. The extension 118 displays the list of relevant items on the client device 116 such that the user can retain view of the third-party content while browsing the list of supplemental items. In one embodiment, the extension 118 displays the relevant items in a user interface (UI) generated by the extension 118. The UI may be, for example, overlaid on top of the page containing the third-party content. In another embodiment, the extension 118 displays the relevant items in the page of the application that displays the third-party content. For example, the extension 118 may alter the page of a mobile application displaying the third-party content to embed relevant video items on a bottom portion of the page.

The extension 118 may also allow users to select and access the content of the relevant items without generating a new page of the application. In one instance, the extension 118 displays the content of the selected items in a UI generated by the extension 118. For example, the extension 118 may generate a modal window dedicated to playing a supplemental video item selected by the user. The dedicated window may be overlaid on top of the page containing the third-party content. In another instance, the extension 118 displays the content of the selected items within the page that displays the third-party content. For example, the extension 118 may play an embedded video item on the page of the third-party content responsive to a user selection to access the item.

In one embodiment, the extension 118 retrieves relevant supplemental items responsive to a trigger event by the user of the client device 116. Specifically, the trigger event may indicate a request by the user of the client device 116 for supplemental items related to third-party content. In one instance, the extension 118 receives requests for relevant items through a UI generated by the extension 118, and user interaction with the UI. The user interactions with the UI, such as an icon, may trigger the extension 118 to retrieve relevant supplemental items for the user of the client device 116. For example, the extension 118 may display an icon on the page of the third-party content that users can interact with to request relevant supplemental items. The trigger event may occur when the user hovers over the icon, clicks the icon, or provides a touch input to the icon with the client device 116. In another instance, the trigger event occurs whenever third-party content on the current page of an application is modified or updated. For example, the extension 118 may retrieve and display relevant supplemental items to the user of the client device 116 responsive to a new webpage displayed by the application.

The supplemental content provider 110 is an online system that manages a set of supplemental content items. In one particular embodiment referred throughout the remainder of the specification, the supplemental items are videos items. In other embodiments, the supplemental items can be content items such as wikis, webpages, audio files, and the like. In one example, the supplemental content provider 110 is an online education system, such as a massive open online course (MOOC) system that provides online courses and curriculums to users through various components such as video lectures and graded assignments. In such an example, the online education system manages a set of supplemental items that are video lecture items. In other examples, the supplemental content provider 110 may be a provider that manages a collection of wiki pages, a provider of a video-sharing website, and the like.

The supplemental content provider 110 builds and manages extension packages that can be installed as extensions 118 on client devices 116 for retrieving relevant supplemental items. The supplemental content provider 110 may build extension packages that can be installed on different types of applications. For example, the supplemental content provider 110 may build one extension package that can be run as an extension 118 in browser application A, and another that can be run as an extension 118 in a different browser application B. The supplemental content provider 110 may provide the extension packages to webstores of corresponding applications, or on the website of the supplemental content provider 110, such that users can download and install the extension packages on client devices 116.

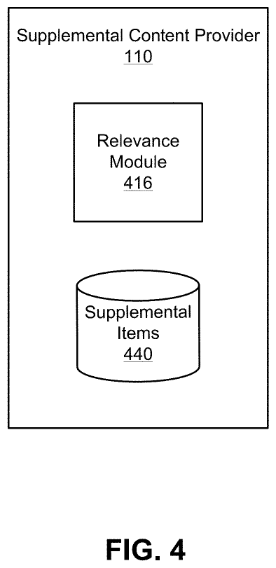

The supplemental content provider 110 receives information on third-party content from the extension 118, and provides relevant supplemental items to the client device 116. The supplemental content provider 110 may perform semantic and/or topic analysis to identify relevant items associated with the third-party content based on information on the supplemental items. For example, information on video items may include a set of keywords extracted from transcripts of the video items. Responsive to receiving information on a third-party news article, the supplemental content provider 110 may extract keywords from the article, and provide relevant video items that have the highest number of matching keywords with the article to the client device 116. A more detailed description of the supplemental content provider 110 is provided in conjunction with FIG. 4.

The client devices 116, the third-party system 114, and the supplemental content provider 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

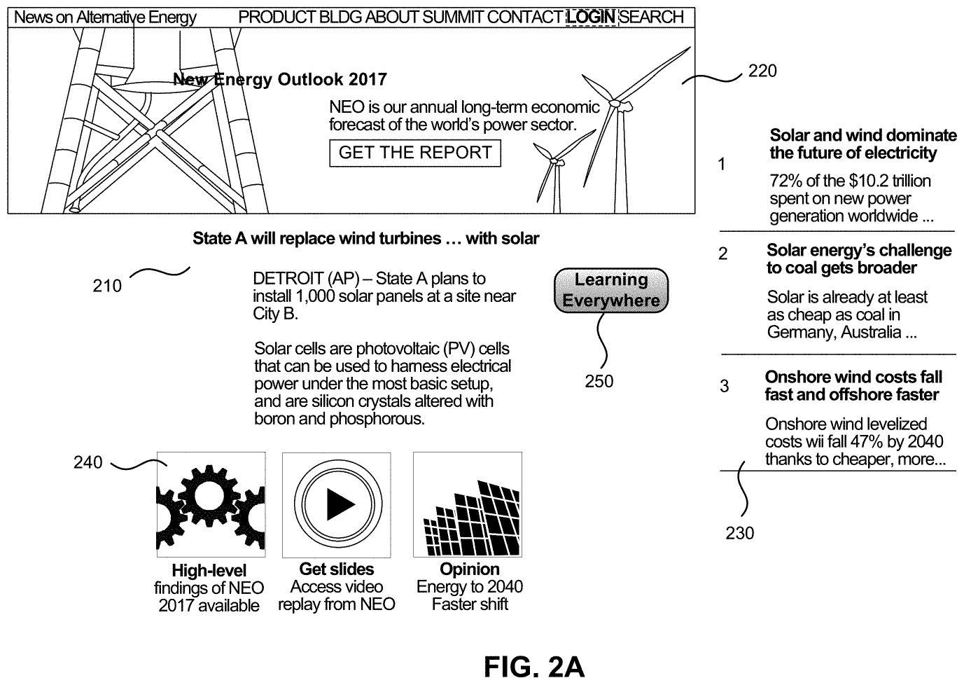

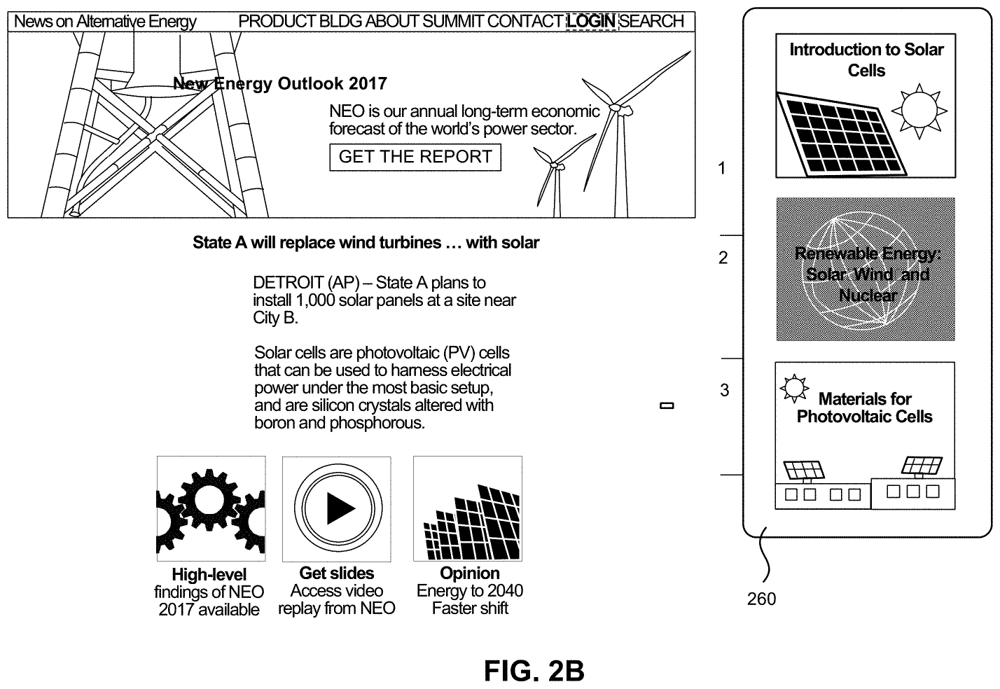

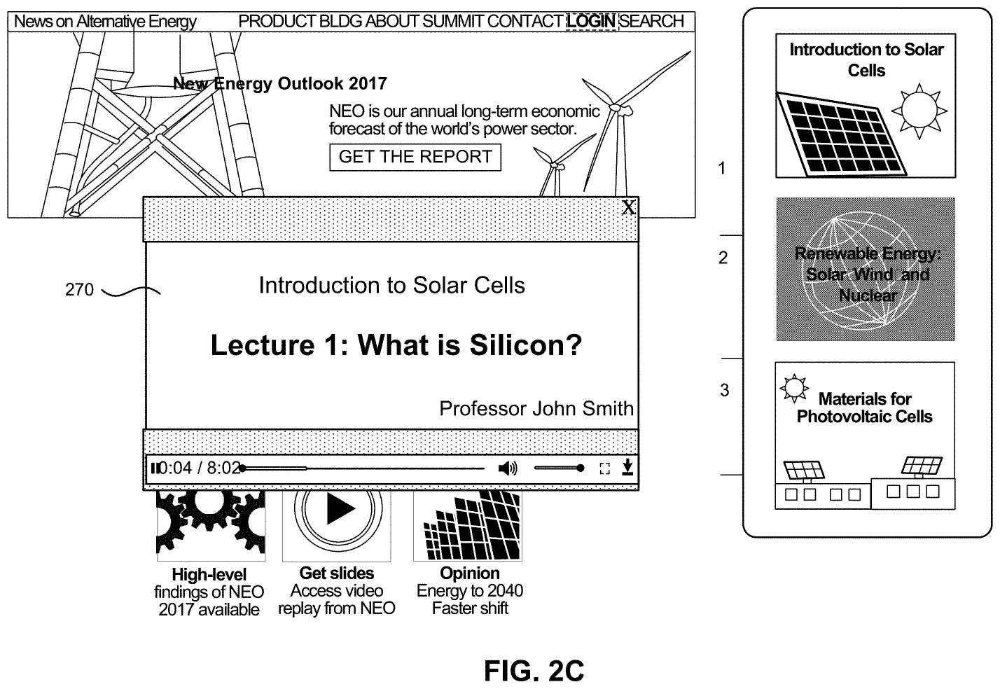

FIG. 2A illustrates an example of a page including third-party content, according to one embodiment. FIG. 2B illustrates the example page in FIG. 2A overlaid with a UI for displaying relevant items, according to one embodiment. FIG. 2C illustrates the example page in FIG. 2A overlaid with a UI for accessing a selected supplemental item, according to one embodiment.

FIG. 2A shows a browser application of a client device 116 displaying a page of a third-party system 114. The page of the third-party system 114 includes third-party content in the form of a news article 210 titled “State A will replace wind turbines . . . with solar.” The page also includes other components, such as the banner 220 of the news website, a list 230 of related articles on the website, and a list 240 of sponsored items provided by organizations other than the third-party system 114 at the bottom of the page. The extension 118 installed on the browser application provides a UI icon 250 labeled “Learning Everywhere” that the user can interact with to trigger retrieval of supplemental items related to the content of the news article 210 from a supplemental content provider 110 that is an online education system.

FIG. 2B shows a UI 260 generated by the extension 118 that displays a list of relevant video items, responsive to user interaction with the UI icon 250. The list of relevant video items include video lecture items titled “Introduction to Solar Cells,” “Renewable Energy: Solar, Wind, and Nuclear,” and “Materials for Photovoltaic Cells,” all of which were identified by the online education system as being relevant to the content of the news article 210. The UI 260 is placed near a side region of the browser application window and overlaid on top of the page, such that the user of the client device 116 can still view the news article 210.

FIG. 2C shows a dedicated window 270 generated by the extension 118 that displays the content of the video item “Introduction to Solar Cells,” responsive to user selection of the video item through the UI 260. The dedicated window 270 may be a modal window. As shown in FIG. 2C, the dedicated window 270 generated by the extension 118 can play the selected video item and allows the user to perform various functions, such as playing the video, pausing the video, adjusting the audio volume of the video, and downloading the video. The dedicated window 270 is also overlaid on top of the page, such that the user does not have to view the video item by opening a new window of the application.

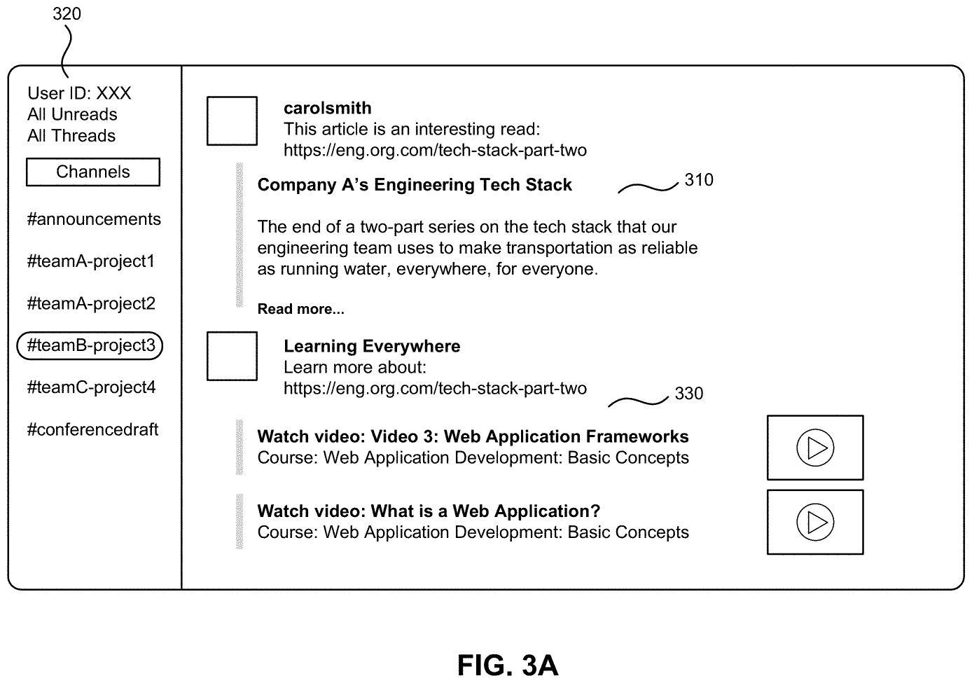

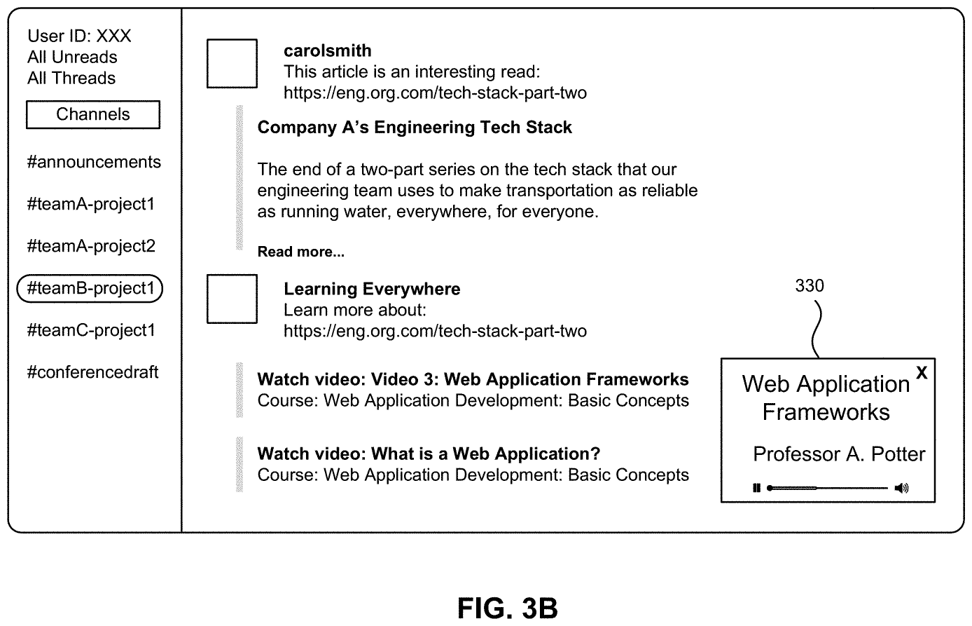

FIG. 3A illustrates an example of a page including third-party content and a list of relevant supplemental items, according to one embodiment. FIG. 3B illustrates accessing a selected supplemental item within the example page of FIG. 3A, according to one embodiment.

FIG. 3A shows a native application of a client device 116 displaying a page of a third-party system 114. The native application is a shared digital workspace among members of an organization, and the page shows the workspace for project 3 shared among members of team B. The page of the third-party system 114 includes third-party content in the form of a news article 310 shared by user “carolsmith” titled “Company A's Engineering Tech Stack.” The page also includes other components, such as the navigation panel 320 of the application. The extension 118 installed on the native application displays a post 330 at the bottom of the workspace that includes a list of video items related to the shared news article 310. The list of relevant video items include video lecture items titled “Web Application Frameworks” and “What is a Web Application?” all of which were identified by the online education system as being relevant to the content of the news article 310. The list of relevant items is displayed as a post within the page of the application, such that the user of the client device 116 can still view the news article 310.

FIG. 3B shows displaying the content of the video item “Web Application Frameworks,” responsive to user selection of the video item. As shown in FIG. 2C, the selected video item 330 can be played within the page of the application. The video item 330 can be accessed within the same page of the third-party content, without requiring the user to view the video item in a new window of the application.

FIG. 4 is a block diagram illustrating components of the supplemental content provider 110, according to one embodiment. The supplemental content provider 110 shown in FIG. 4 includes a relevance module 416. The supplemental content provider 110 also includes a supplemental items store 440. In other embodiments, the supplemental content provider 110 may include additional, fewer, or different components for various applications. Conventional components such as network interfaces, security functions, load balancers, failover servers, management and network operations consoles, and the like are not shown so as to not obscure the details of the system architecture.

The supplemental content provider 110 manages a set of supplemental items 440. The supplemental items store 440 may also store various types of information on the supplemental items. The information may include content data and metadata. Content data includes information directly related to the content of the supplemental items 440. Content data may include transcription of video or audio items that converts speech in the supplemental item to text. For example, content data of a video lecture item may include a transcription of the lecture delivered by the instructor of the supplemental item.

Metadata may describe various aspects of the supplemental items, and may include the author(s), title, and generation date of a supplemental item. The metadata may also include information summarizing the content of supplemental items, and may include a set of keywords or a set of topics or concepts associated with a supplemental item. For example, a video lecture item on solar cells may be associated with a set of keywords “photovoltaics,” “p-n junction,” and “solar cells.” The video lecture item may also be associated with a set of high-level topics “alternative energy” and “solar energy.” The metadata may also include embedding vectors of the supplemental items 440 that are numerical vector representations of the supplemental items 440 in latent space determined by applying latent embedding models to the content of the supplemental items 440.

The relevance module 416 receives information on third-party content from client devices 116, and provides the client devices 116 with supplemental items 440 related to the third-party content. In one embodiment, the relevance module 416 may also receive authentication information of a client device 116 that the relevance module 416 can use to verify whether the user associated with the device is allowed access to the supplemental items 440. In one embodiment, the relevance module 416 may also filter out components (e.g., links to other articles, advertisements) in the information that are not directly related to the third-party content when, for example, the information contains the page of the third-party content.

The relevance module 416 identifies one or more relevant supplemental items based on the third-party content and information associated with the supplemental items 440. The relevance module 416 obtains information on the set of supplemental items 440, and compares the information on the third-party content to the information on the set of supplemental items 440 to identify a set of relevant supplemental content items. For example, the relevance module 416 may extract a set of keywords from the third-party content and identify supplemental items 440 that are associated with the highest number of matching keywords as the relevant items. As another example, the relevance module 416 may determine one or more topics associated with the third-party content, and identify supplemental items 440 that are associated with the determined topics as the relevant items. As yet another example, the relevance module 416 may use embedding models, such as word2vec or doc2vec models, to generate one or more embedding vectors of the third-party content, and identify supplemental items 440 that are associated with the nearest-neighbor embedding vectors as the relevant items. The relevance module 416 provides the set of relevant supplemental content items to the client device 116 for display.

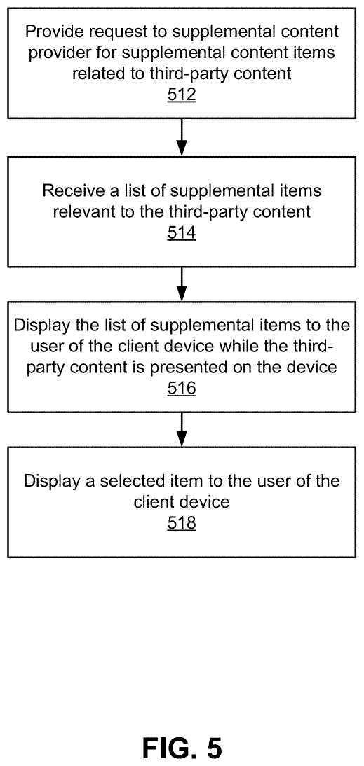

FIG. 5 is an example flowchart for displaying supplemental items related to third-party content on a client device 116, according to one embodiment. In some embodiments, the process shown in FIG. 5 is performed by the extension 118 of the client device 116, although some or all of the operations in the method may be performed by other entities in other embodiments. In some embodiments, the operations in the flow chart are performed in a different order and can include different and/or additional steps.

The extension 118 provides 512 a request to the supplemental content provider 110 for supplemental content items related to third-party content presented on a page of an application on the client device. The third-party content is provided by a third-party system 114. The user of the client device 116 can browse third-party content through one or more applications on the client device 116. The request includes information on the third-party content, and the supplemental content provider is configured to obtain information on a set of supplemental content items, and identify a set of relevant supplemental content items related to the third-party content by comparing the information on the third-party content to the information on the set of supplemental content items. The extension 118 receives 514 a list of supplemental items that are relevant to the third-party content. The supplemental items can be, for example, video items. The extension 118 displays 516 the list of supplemental items to the user of the client device 116. In one embodiment, the extension 118 may generate a UI for displaying the items. In another embodiment, the extension 118 may display the items within the page of the third-party content. The extension 118 may display the list of supplemental items such that the user maintains view of the third-party content while the third-party content is presented on the page of the client device. Responsive to user selection, the extension 118 displays 518 the selected item on the client device 116. Similarly to 516, the extension 118 may generate a UI for displaying the supplemental item, or may display the item within the page of the third-party content. This allows the user to view the content of supplemental items without opening a new window of the application.

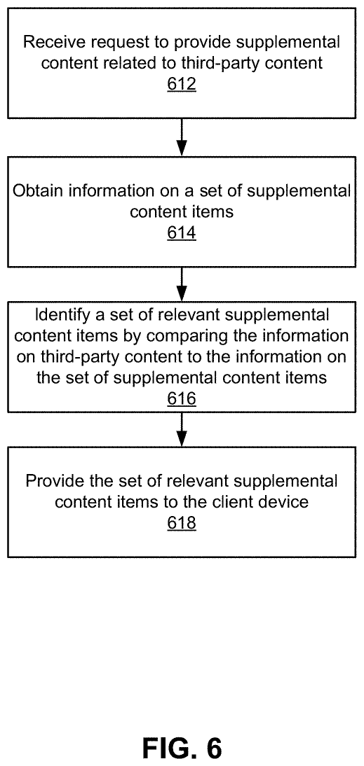

FIG. 6 is an example flowchart for providing supplemental items related to third-party content on a client device 116, according to one embodiment. In some embodiments, the process shown in FIG. 6 is performed by the supplemental content provider 110, although some or all of the operations in the method may be performed by other entities in other embodiments. In some embodiments, the operations in the flow chart are performed in a different order and can include different and/or additional steps.

The supplemental content provider 110 receives 612 a request to provide supplemental content items related to third-party content presented on a page of an application on the client device 116. The request includes information on the third-party content. The supplemental content provider 110 obtains 614 information on a set of supplemental content items. The supplemental content provider 110 identifies 616 a set of relevant supplemental content items from the set of supplemental content items by comparing the information on the third-party content to the information on the set of supplemental content items. The supplemental content provider 110 provides 618, to the extension 118 of the client device 116, the set of relevant supplemental content items. The extension 118 is configured to present the set of relevant supplemental content items on the client device 116 while the third-party content is presented on the page of the client device 116.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for presenting supplemental content items related to third-party content presented on a client device, comprising:
providing, by the client device, a request to a supplemental content provider for supplemental content items related to the third-party content presented on a page of an application on the client device, the request including information on the third-party content, and the supplemental content provider configured to:
obtain information on a set of supplemental content items, and
identify a set of relevant supplemental content items related to the third-party content by comparing the information on the third-party content to the information on the set of supplemental content items;
receiving the set of relevant supplemental content items from the supplemental content provider; and
presenting the set of relevant supplemental content items on the client device while the third-party content is presented on the page of the client device.

2. The method of claim 1, wherein the third-party content is text, and the set of relevant supplemental content items are video items.

3. The method of claim 1, wherein the page is a webpage of a browser application, and wherein the information on the third-party content includes a URL address to the webpage, or a code of the webpage in markup language.

4. The method of claim 1, wherein the third-party content includes text, and providing the request comprises filtering out components in the page that are not related to the third-party content, and extracting the text of the third-party content as the information on the third-party content.

5. The method of claim 1, wherein presenting the set of relevant supplemental content items comprises generating a user interface (UI) including the set of relevant supplemental content items such that the UI is overlaid on the page of the application.

6. The method of claim 1, further comprising responsive to user selection of a relevant supplemental content item in the set, displaying content of the relevant supplemental content item in a modal window.

7. The method of claim 1, wherein presenting the set of relevant supplemental content items comprises displaying the set of relevant supplemental content items within the page of the application.

8. The method of claim 7, further comprising responsive to user selection of a relevant supplemental content item in the set, displaying content of the relevant supplemental content item within the page of the application.

9. The method of claim 1, further comprising:
generating a user interface (UI) element on the page of the application, and
providing the request to the supplemental content provider responsive to user interaction with the UI element.

10. The method of claim 1, further comprising providing the request to the supplemental content provider responsive to loading the page on the client device.

11. A method for providing supplemental content items related to third-party content presented on a client device, comprising:
receiving, from the extension for the application on the client device, a request to provide supplemental content items related to the third-party content presented on a page of the application, the request including information on the third-party content;
obtaining information on a set of supplemental content items;
identifying a set of relevant supplemental content items from the set of supplemental content items by comparing the information on the third-party content to the information on the set of supplemental content items; and
providing, to the extension for the application, the set of relevant supplemental content items, the extension configured to present the set of relevant supplemental content items on the client device while the third-party content is presented on the page of the client device.

12. The method of claim 11, wherein the third-party content is text, and the set of relevant supplemental content items are video items.

13. The method of claim 11, wherein the page is a webpage of a browser application, and wherein the information on the third-party content includes a URL address to the webpage, or a code of the webpage in markup language.

14. The method of claim 11, wherein the third-party content includes text, and identifying the set of relevant supplemental content items comprises filtering out components included in the information on the third-party content that are not related to the third-party content, and extracting the text of the third-party content.

15. The method of claim 11, wherein the information on the set of supplemental content items includes for each supplemental content item, one or more keywords associated with the supplemental content item, and identifying the set of relevant supplemental content items comprises:
extracting one or more keywords from the information on the third-party content; and
identifying the set of relevant supplemental content items from the set of supplemental content items that have a threshold number of matching keywords with the one or more keywords extracted from the third-party content.

16. The method of claim 11, wherein the information on the set of supplemental content items includes for each supplemental content item, an embedding vector associated with the supplemental content item that represents the supplemental content item in a latent vector space, and identifying the set of relevant supplemental content items comprises:
obtaining an embedding vector for the third-party content that represents the third-party content in the latent vector space; and
identifying the set of relevant supplemental content items from the set of supplemental content items that are associated with embedding vectors having less than a threshold distance from the embedding vector of the third-party content.

17. The method of claim 11, wherein the extension is further configured to present the set of relevant supplemental content by generating a user interface (UI) including the set of relevant supplemental content items such that the UI is overlaid on the page of the application.

18. The method of claim 11, wherein responsive to user selection of a relevant supplemental content item in the set, the extension is further configured to display content of the relevant supplemental content item in a modal window.

19. The method of claim 11, wherein the extension is further configured to present the set of relevant supplemental content items by displaying the set of relevant supplemental content items within the page of the application.

20. The method of claim 11, wherein responsive to user selection of a relevant supplemental content item in the set, the extension is further configured to display content of the relevant supplemental content item within the page of the application.
